(19) United States
(12) Patent Application Publication
(10) Pub. No.: US 2023/0339825 A1
(43) Pub. Date: Oct. 26, 2023

(54) SYSTEM OF BELOW GROUND COMPOSTING

(71) Applicant: Syntro Biosystems (Holding) Pty Ltd., Byron Bay (AU)

(72) Inventors: Andrew HAYIM DE VRIES, Byron Bay, (AU); Peter HOWARD, Byron Bay (AU)

(21) Appl. No.: 18/214,546

(22) Filed: Jun. 27, 2023

Related U.S. Application Data
(63) Continuation-in-part of application No. 16/634,153, filed on Jan. 26, 2020.

(30) Foreign Application Priority Data
Jul. 27, 2017 (AU) 2017902953

(51) Int. Cl. C05F 17/971; C05F 17/993

(52) U.S. Cl. CPC C05F 17/971; C05F 17/993

(57) ABSTRACT

A composting system comprising a composting bin containing a composting material: the bin embedded at least partially below a ground surface in a root zone; the bin forming an enclosure including porous side portions and a non-porous base portion; the side portions provided with holes to allow ingress and egress of worms while excluding vermin; the holes further allowing nutrients exuded by composting material in the bin to leach into surrounding soil: the bin embedded in a root zone in a soil mass.

The present invention relates to a system of below ground composting including apparatus and a method for enhancing plant growth via a below ground composting system.

### BACKGROUND

Composting systems are well known in the art. Typically, these systems comprise of a composting bin that sits above ground where the composting process is completed and then the resulting compost is distributed from that bin to its desired usage location. This method, while popular, requires many handling steps including but not limited to moving the bin to encourage the composting process and then manually distributing the resulting compost to its desired usage location.

A recent trend is for users to place the composting bin in the ground in the actual location where the resulting compost is needed and to allow the nutrients from the composting bin to leak from the bin into the surrounding soil. This allows the resulting compost to be accessible to the soil in which the user wishes to target the use of the compost.

Typically, such a system would involve something like a metal barrel where the bottom of the barrel is cut off and the waste material is added from the top of the barrel and the nutrients and compost leach from the bottom of the barrel. The problem with this design is that it does not incorporate needed air flow that is an important part of the composting process. The design also allows rodents and pests to access the compost, typically by digging down and coming up into the barrel or other bin. This is highly undesirable.

In WO2000032540A1 (Firkin) and US20040029262A1 (Walker), the structure either suspends the composting system above the ground, is resting on the surface of the soil (U.S. Pat. No. 3,947,357 (Cherry), AU 2016100278A4 (Wallis)) or in the one application below ground (U.S. Pat. No. 5,185,261 (Warrington)), the wire basket allowing contact within the soil, is placed only at the bottom of the chamber, which is a location that poorly facilitates the opportunity to couple the root stimulating activity of all of the generated compost to the full soil region of roots of any plants growing in proximity to the composting unit.
1. U. Tomati, A Grappelli and E. Galli (1988) “The hormone-like effect of earthworm casts upon plant growth” Biology and Fertility of Soils 5, pp 288-294. This is a major review of the plant stimulating properties of many earthworm types including compost worm
2. J. K. Syers and J. A. Springett (1984) “Earthworms and soil fertility” Plant and Soil 76, pp 93-104
3. P. D. Goodwin and Higgens T J V (1978) “Phytohormones and growth and development of organs of the vegetative plant” from Phytohormones and related compounds: A comprehensive treatise. Elsevier Oxford New York pp 31-173

The described invention is designed to address these issues or at least provide a useful alternative.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

### Definitions

Composting worms: in this specification composting worms refers to worms which are adapted to efficiently process food waste so as to produce castings which contain biologically active microbes.

Compostable material: in this specification compostable material comprises mainly food waste, vegetable matter and sources of dry carbon material. The dry carbon material can include sawdust and coconut coir.

Accordingly in one broad form of the invention there is provided a worm composting system comprising a composting chamber containing a composting material: the chamber embedded at least partially below a ground surface in the root zone Rhizosphere); the chamber forming an enclosure including porous side portions and a non-porous base portion; the side portions provided with holes to allow ingress and egress of worms while excluding vermin; the holes further allowing nutrients and worm castings exuded by composting worms in the chamber to leach into surrounding soil: the chamber embedded in the root zone in a soil mass; whereby, in use, said composting chamber is filled with compostable material and worms pass from the interior of the composting chamber and excrete their castings into the surrounding soil so as to generate a hormone-like signal attracting roots of plants located in the Rhizosphere to grow towards the castings containing active microbes that the plant roots can ingest directly as a nutrient source.

Preferably the soil mass extends to a depth of actively growing roots of food producing plants.

Preferably the composting bin is embedded to a depth of active nutrient and microbial uptake by plant roots in the root zone.

Preferably the holes are sized to suit diameters of worms typical of the surrounding soil in which the bin is located; the holes sufficiently small to prevent ingress of vermin such as rats.

Preferably the non-porous base portion comprising a solid structure;

Preferably the bin is further provided with an upper aeration section; the upper aeration section projecting in use above the ground surface.

Preferably the upper aeration section is provided with apertures; the apertures provided with a mesh adapted to prevent ingress of rats or other vermin.

Preferably the bin is provided with a lid; the lid substantially coextensive with the upper aeration section.

Preferably the lid is provided with a lockable mechanism.

Preferably side portions of the bin are stepped; the side portions decreasing in size from a maximum for the upper portion to a minimum for the lowermost portion; the arrangement allowing for collapsing of lower portions of the bin into the upper portion for storage and transport.

Preferably the side portions of the bin are substantially planar; the side portions provided with indented or projecting strengthening sections.

Preferably ends of each bin are provided with male and female interlocking structures; a first end of a bin provided with a male interlocking structure and an opposite second end with a female interlocking structure.

Preferably the male and female interlocking structures allow a number of bins to be interconnected to provide a continuous composting and nutrient producing barrier below a ground surface.

The system of claim 1 wherein the bin is provided with sensors monitoring composting performance.

Preferably the sensors include a temperature sensor.

Preferably the sensors include a moisture level sensor.

Preferably the sensors include a soil acidity sensor.

In yet a further broad form of invention there is provided a method of promoting composting including leaching of nutrients into surrounding soil; the method including the steps of:
providing a composting bin comprising porous side portions and a non-porous base portion; the side portions provided with plurality of holes,
placing the composting bin substantially embedded below a ground surface in a root zone in a soil mass; an upper aeration portion of the bin projecting above the ground surface, and
wherein the holes are sized to allow ingress and egress of worms into and out of the bin but prevent ingress of rats and other vermin.

Preferably the holes allow nutrients exuding from compostable material in the bin to leach into soil surrounding the bin.

Preferably each composting bin is provided with interlocking structures at each end of the bin; the interlocking structures allowing a line of bins to form a composting and nutrient producing barrier.

Preferably the composting bin is provided with sensors to monitor composting performance; the sensors including temperature, moisture level and soil acidity sensors.

In yet a further broad form of the invention there is provided a method of natural fertilisation of plants located in a Rhizosphere; method comprising:
locating a composting chamber within the Rhizosphere of ground; said chamber having sidewalls subtending from a base; apertures located in said sidewalls for communication between the interior of the composting chamber and the Rhizosphere adjacent the composting chamber; said apertures sized to permit passage of composting worms; whereby, in use, said composting chamber is filled with compostable material and worms consume the compostable material generating worm castings which possess a hormone-like signal attracting roots of plants located in the Rhizosphere to grow towards the castings and castings supply actively replicating microbes that the plant roots can ingest directly as a nutrient source.

Accordingly in yet a further broad form of the invention there is provided a composting bin adapted to embedding at least partially below a ground surface; the bin forming an enclosure including side portions and a base portion; the side portions and the base portions provided with holes to allow ingress and egress of worms while excluding vermin; the holes further allowing nutrients exuded by composting material placed in the bin to leach into surrounding soil.

Preferably the holes are sized to suit diameters of worms typical of the surrounding soil in which the bin is located; the holes sufficiently small to prevent ingress of vermin such as rats.

Preferably the bin is further provided with an upper aeration section; the upper aeration section projecting in use above the ground surface.

Preferably the upper aeration section is provided with apertures; the apertures provided with a mesh adapted to prevent ingress of rats or other vermin.

Preferably the bin is provided with a lid; the lid substantially coextensive with the upper aeration section.

Preferably the lid is provided with a lockable mechanism.

Preferably side portions of the bin are stepped; the side portions decreasing in size from a maximum for the upper portion to a minimum for the lowermost portion; the arrangement allowing for collapsing of lower portions of the bin into the upper portion for storage and transport.

Preferably the side portions of the bin are substantially planar; the side portions provided with indented or projecting strengthening sections.

Preferably ends of each bin are provided with male and female interlocking structures; a first end of a bin provided with a male interlocking structure and an opposite second end with a female interlocking structure.

Preferably the male and female interlocking structures allow a number of bins to be interconnected to provide a continuous composting and nutrient producing barrier below a ground surface.

Preferably the bin is provided with sensors monitoring composting performance.

Preferably the sensors include a temperature sensor.

Preferably the sensors include a moisture level sensor.

Preferably the sensors include a soil acidity sensor.

In yet a further broad form of the invention there is provided a method of promoting composting including leaching of nutrients into surrounding soil; the method including the steps of:
providing a composting bin comprising side portions and a base portion; the side portions and base portions provided with plurality of holes,
placing the composting bin substantially embedded below a ground surface; an upper aeration portion of the bin projecting above the ground surface, and
wherein the holes are sized to allow ingress and egress of worms into and out of the bin but prevent ingress of rats and other vermin.

Preferably the holes allow nutrients exuding from compostable material in the bin to leach into soil surrounding the bin.

Preferably each composting bin is provided with interlocking structures at each end of the bin; the interlocking structures allowing a line of bins to form a composting and nutrient producing barrier.

Preferably the composting bin is provided with sensors to monitor composting performance; the sensors including temperature, moisture level and soil acidity sensors.

In yet a further broad form of the invention there is provided a composting bin adapted to partial burial in soil; the bin comprising of side portions, a base portion and an upper aeration portion; the upper aeration portion projecting above a ground surface in use; the side portions and the base portion provided with holes for ingress and egress of worms and for leaching into surrounding soil nutrients produced from compostable material placed in the bin.

### DRAWINGS

Embodiments of the present invention will now be described with reference to the accompanying drawings wherein:

FIG. 1A is a cross section of a first preferred embodiment of a composting bin according to the invention

FIG. 1B is a cross section of a second preferred embodiment of a composting bin according to the invention

FIG. 10 is a cross section of a third preferred embodiment of a composting bin according to the invention

FIG. 2 illustrates a worm access hole diameter of the preferred embodiments

FIG. 3 comprises side views of a fourth preferred embodiment of the invention

FIG. 4 is a perspective view of a further embodiment of the invention, in use.

### DESCRIPTION AND OPERATION

### First Preferred Embodiment

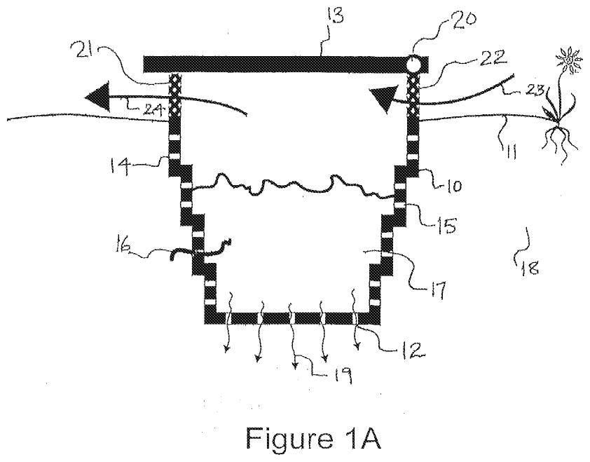

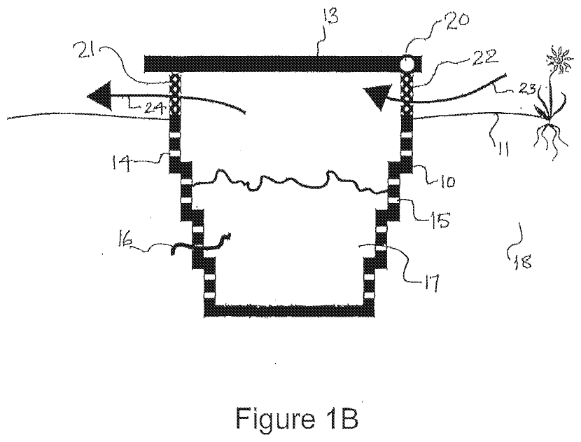

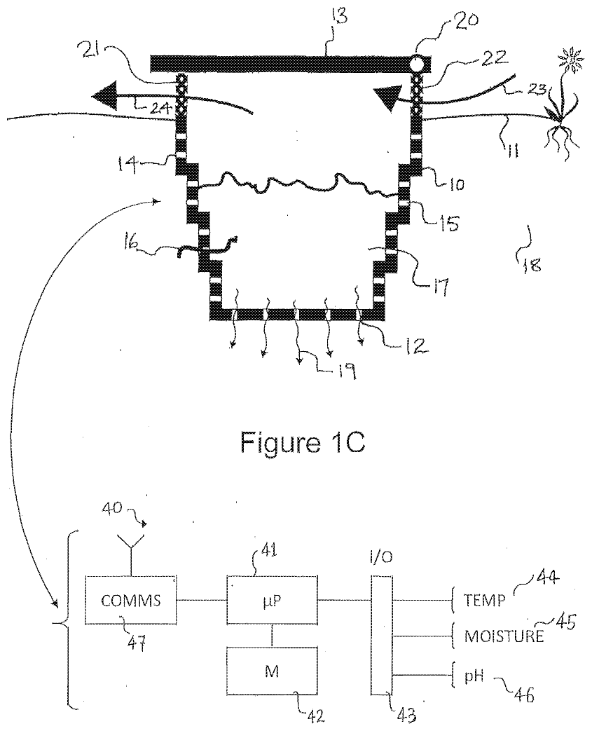

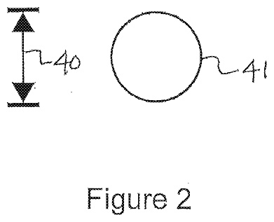

FIG. 1A discloses a cross section of a first embodiment of the invention comprising a composting bin 10 that has a main body that sits substantially under the level of the surface of the ground 11. This first preferred embodiment shows a stepped wall design that makes the composting bin 10 easy to store during transport and storage and is known in the art. The side walls of the bin and its floor or base portion 12 and lid 13 are made of a rodent resistant material provided with holes 14 15 throughout which allow worms 16 and other organisms to pass between the compost 17 and the surrounding dirt 18.

As the compost 17 decomposes the resulting fluid 19 passes through the holes in the bin to improve the condition of the surrounding soil 18.

The example embodiment shows a lid 13 pivoting about a hinge 20 that allows a user to add materials to the composting mix 17.

The lid 13 sits on top of an aeration structure 21 22. In this example embodiment the aeration structure is a metal mesh 21 22 that allows air 23 to pass through 23 24 the compost bin. This allows the compost process area to naturally regulate its temperature. The mesh 21 22 is designed to allow air to circulate without allowing rodents to enter the compost bin.

The result is a compost bin that does not require the collection and redistribution of compost nutrients but rather can automatically distribute the nutrients in situ while being resistant to rodent infestation. The aeration capability of the design also allows the invention to automatically regulate the temperature of the composting process by allowing heat to escape, which is also desirable.

### Second Preferred Embodiment

With reference to FIG. 1B there is illustrated a second embodiment wherein, in this instance, the composting bin 10 does not have holes 14 within the floor or base portion 12.

### Third Preferred Embodiment

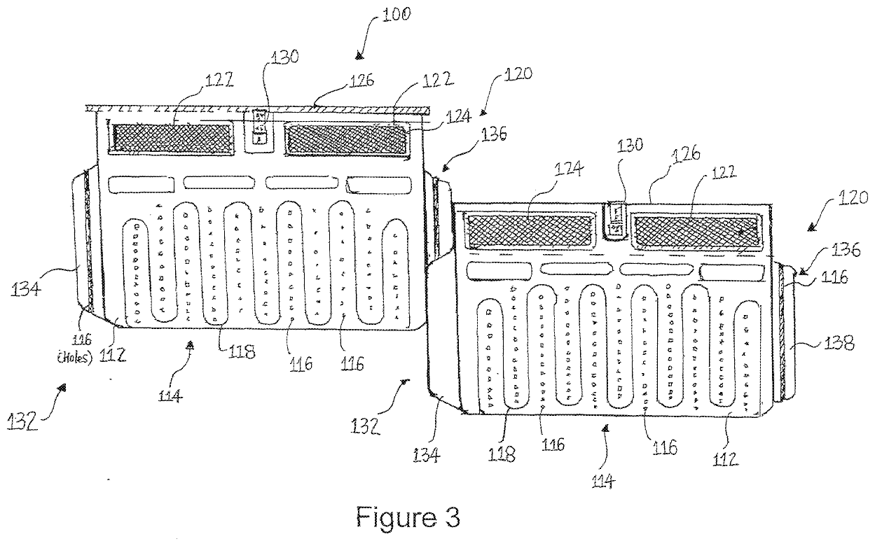

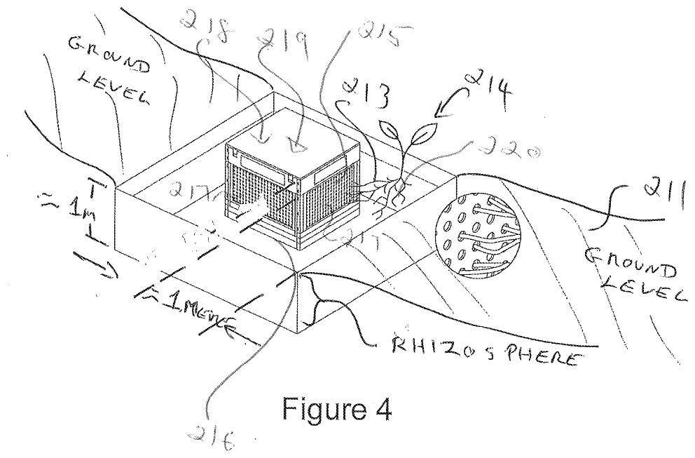

With reference to FIG. 10 there is illustrated a third embodiment of the composting bin 10 which, in this instance, is fitted with a monitor unit 40 which in this instance comprises a processor 41 in communication with a memory 42. The processor 41 is further in communication with an input output unit 43 by which signals from sensors such as temperature sensor 44, moisture sensor 45, acidity sensor 46 may be transmitted to the processor 41 for further processing. In some instances the processor 41 may communicate the signals or information otherwise derived from the sensors to a communications module 47 for on-communication—for example to a remote database or like facility.

FIG. 2 discloses the ideal diameter size of the worm access holes. The diameter 40 should be greater than the diameter of the desired worms to be used in the composting process and small enough to not allow rodents or other undesirable animals from gaining access to the interior of the compost bin. In the example embodiment the hole 41 is round.

### Fourth Preferred Embodiment

With reference now to FIG. 3, in a further embodiment of the invention, a compost bin 100 is formed of side portions 112 and a base portion 114. As in the first preferred embodiment described above, both the side portions 112 and the base portion 114 are provided with holes 116 which again allow the ingress and egress of worms while excluding vermin, as well as allowing nutrients exuding from composting material in the bin to leach into the surrounding soil. Preferably, the holes are sized to suit the diameters of worms typical to the surrounding soil.

In this embodiment, the side walls 112 of the composting bin 100 are substantially planar but are preferably provided with indentations 118 or projections to strengthen the walls against pressure from the surrounding soil when the composting bin is substantially embedded in soil for use. As for the first preferred embodiment above, the composting bin is provided with an upper aeration section 120 which, in use, projects above a ground surface. The upper aeration section 120 includes apertures 122 which are provided with mesh 124 to allow a free flow of air while preventing ingress of rats or other vermin. A hinged lid 126, substantially coextensive with the upper aeration section 120, provides access for adding or removing composting material. Preferably the lid 126 is provided with a lockable mechanism 130.

A further feature of this second preferred embodiment of the composting bin 100 is the provision at the ends of the bin with interlocking male and female structures. Thus, at a first end 132 of each bin is an integral male interlocking structure 134 while at a second opposite end 136 the bin is provided with a female interlocking structure 138. These interlocking structures allow a number of bins 100 to be interconnected to provide a continuous composting and nutrient providing barrier below a ground surface.

To monitor the performance of the composting bin of either of the above described embodiments, composting bins of the invention may be provided with monitoring sensors, such as temperature, moisture and acidity (pH) levels. In some arrangements these may provide read out data of current or recorded measurements via some communication system such as Bluetooth or over a mobile phone network for remote monitoring.

### Alternative Embodiments

The preferred embodiments preferably use a steel mesh for aeration. An alternative embodiment could use any aeration material that allows air to pass through the top area but stops rodents from entering the compost area inside the bin.

The preferred embodiments use round holes in the walls and floor of the bin. An alternative arrangement could use any shape of hole.

The preferred embodiments have the bin compost area situated below the ground level with the aeration mesh sitting above the ground level. An alternative embodiment could see the bin used at any height relative to the ground level however it is noted that the configuration in the above described embodiments is the preferred configuration.

The preferred embodiments use a recycled hardened plastic for the bin body. Alternative arrangements could use any material that is rodent resistant and will not deteriorate or break down due to the composting process.

### Further Preferred Embodiments

FIG. 4 is a perspective view of a further embodiment of the invention, in use.

With reference to FIG. 4 there is illustrated a fifth embodiment of an installation comprising the composting chamber 210 installed so as to be substantially below ground level 211. In this preferred embodiment the composting chamber 210 extends below ground level within the Rhizosphere 212. It is also within the Rhizosphere 212 that the root systems 213 of plants 214 are most prevalent.

In this embodiment, the composting bin is designed with many holes in all 4 walls for the full region of the composting chamber below the ground, allowing both worm movement in and out of the chamber, and allowing plant roots to enter. By placing these holes in the walls rather than the bottom of the chamber, this design optimally facilitates the interaction between the root promoting activity of the compost and plants grown in proximity to the composting bin composting chamber, as these holes are located in the zone in which plants obtain nutrients from the soil (rhizosphere).

Initially worms travel out through these holes and deposit castings in the soil in proximity to the composting bin. These castings contain hormone-like growth properties to increase plant root production and stimulate the growth of these roots toward the holes and enter the chamber, allowing direct uptake of the microbes within the compost as it is being generated.

In contrast, for each of the composting patents cited by the reviewer, the structure either suspends the composting system above the ground (Firkin and Walker), or is resting on the surface of the soil (Cherry and Wallis) or in the one application below ground (Warrington), the wire basket allowing contact within the soil, is placed only at the bottom of the chamber, which is a location that poorly facilitates the opportunity to couple the root stimulating activity of all of the generated compost to the full soil region of roots of any plants growing in proximity to the composting unit.

The composting bin uniquely facilitates maximal and dynamic nutrient transport from composted food scraps to growing plants with specifically designed porous chamber walls that are optimized to admit plant roots from all four sides through the full depth of the root zone expected for annual plants. By situating the composting bin within a garden bed, either in a raised bed or in-ground, the plants surrounding the composting bin grow with maximal fertility with this design providing a continual access to vermiculture compost as it is being generated within the composting bin. The composting bin facilitates this optimal plant growth in three specific ways:

The design of the chamber allows the entry of plant roots below ground through the walls of the composting bin to feed directly as the compost is generated. Because vermicomposting (the composting method utilized by the composting bin) is a “cool” composting process, the temperature range of the freshly forming compost within the composting chamber is compatible with growing plant roots.

Vermicompost uniquely contains known hormone-like substances that stimulate plant root development. There is extensive science research on this finding. See references 1, 2 and 3 which reviews the body of this work and covers the phenomenon that plant roots will actually grow toward the source of the root growth-stimulating casts. This root stimulating activity of worm casts has been measured in a wide variety of worm species, including the composting worm E. fetida which is the worm species most frequently used in composting bin composting. Earthworm casts when applied to stem cuttings stimulate root initiation, elongation and total root biomass in a dose-dependent manner, with high doses stimulating maximum stimulation (3).

The same holes that allow plant root entry, allow worms to move the root stimulating casts from the composting bin and into the garden bed in proximity to the plant roots. This initiates the signaling that helps direct the plant roots toward and into the composting bin chamber through the holes in the walls.

Another function served by the holes in the wall is at the stage prior to the stage when plant roots have reached through the holes into the compost, soil dwelling mycorrhizal fungal filaments are able to extend through many holes in each of the four composting bin walls to deliver compost nutrients from the composting bin to plants whose roots are still some distance from the holes.

We on all four sides find that plants growing in proximity to the composting bin that have generated compost grow quickly, are more disease resistant and produce maximally abundant crops. The large number of holes underground in the region of the Rhizosphere, maximally supports the delivery of the root-stimulating compounds provided by worms as they exit the composting bin and simultaneously support the entry of the maximal number of feeder roots for plants growing in proximity to the composting bin.

The line drawing of FIG. 4 below illustrates the result of this design in the example of a raised bed, where the soil surrounding the composting bin has been omitted for clarity to show the plant roots growing through the composting bin walls. The same design applies for an in-ground placement.

Soil fertility can be defined as “the inherent capacity of soil to supply nutrients to plants in adequate amounts and in suitable proportions”. Earthworms have important influences on physical and biological effects that affect the nutrient supply to plants.2 It is now known that plants in undisturbed soil can directly uptake specific microbes to obtain these nutrients, utilizing a newly recognized biological process termed The Rhizophagy Cycle (1, 2)

Nutrient availability to plants is dependent on the distance ions diffuse through the soil. One of the three key ions plants require, phosphate diffuses over less than 1 mm. By improving root density and root distribution, more of these ions are easily taken up by plants. Conversely, when microbes within the worm castings, compatible with the Rhizophagy Cycle are in proximity to those roots, these can be uptaken directly to obtain the needed nutrients.

In the context of a raised bed, choosing a well-chosen soilless media that holds water well, drains well, does not compact over time and admits abundant air further augmenting the benefits provided by the composting bin in garden bed design by providing a medium that supports ideal water, air and minimal soil resistance for plant root growth and healthy microbial activity. Approximately 50% coconut coir and equal proportions of perlite, vermiculite and vermicompost works well.

The maximum diameter is 9 mm, most are this size and there are some that are 7 mm to maintain the structural integrity of the walls. In other versions, they could go down to 5 mm and let the worms through, but larger allows worms to crawl around roots growing through at the same time.

In a preferred form, there are no holes at all in the base from which the walls of the composting chamber subtend. In a preferred form, the base is solid.

Choosing a solid base, focuses the nutrients laterally out to the plant root zone to plants growing around the composting bin rather than downwards below the composting bin which would direct nutrients below the region occupied by the root zone of actively growing annual plants where the majority of roots are found in the top foot of soil.

### In Use

The composting chamber 210 when placed in the Rhizosphere 212 of the ground 211 provides the basis for a method of fertilizing plants in the Rhizosphere 212 that does not require chemicals.

Specifically, there is provided a method of natural fertilisation of plants located in a Rhizosphere; the method comprising:
Locating a composting chamber 210 within the Rhizosphere 212 of ground 211; said chamber 210 having sidewalls 215 subtending from a base 216; apertures 217 located in said sidewalls 215 for communication between the interior 218 of the composting chamber 210 and the Rhizosphere 212 adjacent the composting chamber 210; said apertures 217 sized to permit passage of composting worms; whereby, in use, said composting chamber 210 is filled with compostable material and worms pass from the Rhizosphere 212 into the interior 218 of the composting chamber 210 and interact with the compostable material 219 so as to generate a hormone-like signal attracting roots 220 of plants 214 located in the Rhizosphere 212 to grow towards the compostable material 219 and then supply microbes (not shown) that the plant roots 220 can ingest directly as a nutrient source.

### The Scientific Basis

The new understanding of the Rhizophagy Cycle (Rhizo=roots and phagy=eat) that plants have been using in nature to first directly uptake soil bacteria within the structure of their roots and then extract microbial nutrients before returning these microbes to the soil surrounding the roots (1, 2) has profound implications for sustainable farming and gardening practices and stewardship of ecosystem habitats.

One reason this process was only discovered recently is that it primarily occurs in undisturbed and no till soils. A second reason for the delayed discovery is that for plants grown in the presence of chemical fertilizers, the Rhizophagy Cycle is interrupted.

The nutrition provided by the consumed microbes are now known to provide many of the macro and micro nutrients required by plants in natural settings.

Some of the same soil bacteria that are uptaken by the plant roots for consumption are also preferentially generated at high concentrations within the alimentary canal of earthworms, mixed with microbial food and then excreted as casts from the worm in high concentrations in an actively proliferating form suitable for uptake by nearby plant roots utilizing the Rhizophagy Cycle

It has been known for decades that worm casting compost, unlike compost from other composting processes, contains a “hormone-like” signal (3) that attracts plant roots to grow toward the castings, even overcoming positive geotropism (the signal that normally directs roots downwards into the soil). The castings also have a growth stimulating effect that increases plant root production (5).

Combining this new understanding of how plants can uptake their nutrients directly from soil microbes with the root attracting and growth properties of worm compost, we have designed the first continuous flow food composting system that couples the generation of compost directly to nutrient uptake by plant roots using the newly discovered Rhizophagy Cycle. This design uniquely and efficiently facilitates maximal and dynamic nutrient transport from food waste to growing plants. In addition, the process by which plant roots digest away the walls of the microbes to obtain their nutrients utilizes ROS (reactive oxygen species) also helps protect plants against pathogenic soil organisms. Plants actively utilizing the Rhizophagy Cycle for their nutritional inputs are more disease resistant than plants fed with chemical based fertilizers (1, 2).

The composting chamber 210 of the fifth embodiment is designed with many holes in all 4 walls below ground, allowing both worm movement in and out of the chamber, and allowing plant roots to enter. By placing these holes in the walls rather than the bottom of the chamber, which is a solid base, this design optimally facilitates the interaction between the root attracting and growth promoting activity of the compost with plants grown in proximity to the composting chamber 210 of the fifth embodiment composting chamber, as these holes are located at the depth of the soil in which plants roots taking up nutrients and microbes are most abundant (4, 5).

Initially worms travel out through these holes and deposit castings in the soil in proximity to the composting chamber 210 of the fifth embodiment. The castings hormone-like growth properties stimulate the growth of plant roots toward the composting chamber holes whereupon they enter the chamber, allowing direct feeding of the microbes from the compost as it is being generated.

In contrast, for each of the composting patents cited by the reviewer, the structure either suspends the composting system above the ground (Firkin and Walker), or is resting on the surface of the soil (Cherry and Wallis) or in the one application below ground (Warrington), the wire basket allowing contact within the soil, is placed only at the bottom of the chamber, which is a location that poorly facilitates the opportunity to couple the root stimulating activity of the generated compost to the full soil region containing roots plants growing in proximity to the composting unit.

The Composting Chamber couples the generated worm casting compost to optimal plant growth and health in four specific ways:
1) The design of the chamber allows the entry of plant roots below ground through the walls of the composting chamber 210 of the fifth embodiment to feed directly as the compost is generated. Because vermicomposting (the composting method utilized by the fifth embodiment) is a “cool” composting process, the temperature range of the freshly forming compost within the composting chamber is compatible with growing plant roots.
2) The same holes that allow plant root entry allow worms to move their root stimulating casts from the side walls 215 of the composting chamber 210 of the fifth embodiment and into the garden bed in proximity to the plant roots 220. This initiates the signaling that helps direct the plant roots toward and into the composting chamber 210 through the holes in the walls 215.
3) The hormone-like substances that attract plant roots 220 are used to draw the plants 214 to the compost, leaving the soil undisturbed to allow the Rhizophagy Cycle to occur.
4) The worm casting compost which specifically generates high concentrations of the microbes that are uptaken by the plant roots accumulate in the chamber to facilitate the Rhizophagy Cycle, leading to optimal plant nutrition and plant health (1, 2)
   We find that plants growing in proximity to our compost system grow vigorously, are more disease resistant and produce maximally flavorful and abundant crops.
   The line drawing of FIG. 4 illustrates the result of this design in the example, where the soil surrounding the composting chamber 210 of the fifth embodiment has been omitted for clarity to show the plant roots growing through the side walls 215. The same design applies for both an above ground raised bed garden and in-ground placement.

In the context of a raised bed, utilizing a media that holds water well, drains well, does not compact over time and admits abundant air maximizes the benefits of coupling the Rhizophagy Cycle to compost production. One medium that works well for this purpose is 50% coconut coir and 20% perlite, 20% vermiculite and 10% vermicompost.

### REFERENCES

1. Rhizophagy Cycle: An Oxidative Process in Plants for Nutrient Extraction from Symbiotic Microbes by White et al. (2018) J. This is the original review paper that proposed and described the cycle in detail, with experimental evidence from several seed-vectored microbes in several host species.
2. Endophyte roles in nutrient acquisition, root system architecture development and oxidative stress tolerance by Verma et al. (2021). This review summarizes the current knowledge and challenges of the Rhizophagy Cycle, and addresses the implications for sustainable agriculture and plant health.
3. U. Tomati, A Grappelli and E. Galli (1988) “The hormone-like effect of earthworm casts upon plant growth” Biology and Fertility of Soils 5, pp 288-294. This is a major review of the plant stimulating properties of many earthworm types including compost worm
4. J. K. Syers and J. A. Springett (1984) “Earthworms and soil fertility” Plant and Soil 76, pp 93-104
5. P. D. Goodwin and Higgens T J V (1978) “Phytohormones and growth and development of organs of the vegetative plant” from Phytohormones and related compounds: A comprehensive treatise. Elsevier Oxford New York pp 31-173

### INDUSTRIAL APPLICABILITY

Embodiments of the invention are applicable in the horticulture industries for the purpose of improving composting performance and plant growth and health.

1. A worm composting system comprising a composting chamber containing a composting material: the chamber embedded at least partially below a ground surface in the root zone (Rhizosphere); the chamber forming an enclosure including porous side portions and a non-porous base portion; the side portions provided with holes to allow ingress and egress of worms while excluding vermin; the holes further allowing nutrients and worm castings exuded by composting worms in the chamber to leach into surrounding soil: the chamber embedded in the root zone in a soil mass: whereby, in use, said composting chamber is filled with compostable material and worms pass from the interior of the composting chamber and excrete their castings into the surrounding soil so as to generate a hormone-like signal attracting roots of plants located in the Rhizosphere to grow towards the castings containing active microbes that the plant roots can ingest directly as a nutrient source.

2. The system of claim 1 wherein the soil mass extends to a depth of actively growing roots of food producing plants.

3. The system of claim 1 wherein the composting bin is embedded to a depth of active nutrient and microbial uptake by plant roots in the root zone.

4. The system of claim 1 wherein the holes are sized to suit diameters of worms typical of the surrounding soil in which the bin is located; the holes sufficiently small to prevent ingress of vermin such as rats.

5. The system of claim 1 wherein the non-porous base portion comprises a solid structure.

6. The system of claim 1 wherein the bin is further provided with an upper aeration section; the upper aeration section projecting in use above the ground surface.

7. The system of claim 6 wherein the upper aeration section is provided with apertures; the apertures provided with a mesh adapted to prevent ingress of rats or other vermin.

8. The system of claim 6 wherein the bin is provided with a lid; the lid substantially coextensive with the upper aeration section.

9. The system of claim 8 wherein the lid is provided with a lockable mechanism.

10. The system of claim 1 wherein side portions of the bin are stepped; the side portions decreasing in size from a maximum for the upper portion to a minimum for the lowermost portion; the arrangement allowing for collapsing of lower portions of the bin into the upper portion for storage and transport.

11. The system of claim 1 wherein the side portions of the bin are substantially planar; the side portions provided with indented or projecting strengthening sections.

12. The system of claim 1 wherein ends of each bin are provided with male and female interlocking structures; a first end of a bin provided with a male interlocking structure and an opposite second end with a female interlocking structure.

13. The system of claim 12 wherein the male and female interlocking structures allow a number of bins to be interconnected to provide a continuous composting and nutrient producing barrier below a ground surface.

14. The system of claim 1 wherein the bin is provided with sensors monitoring composting performance.

15. The system of claim 14 wherein the sensors include a temperature sensor.

16. The system of claim 14 wherein the sensors include a moisture level sensor.

17. The system of claim 14 wherein the sensors include a soil acidity sensor.

18. A method of promoting composting including leaching of nutrients into surrounding soil; the method including the steps of:
providing a composting bin comprising porous side portions and a non-porous base portion; the side portions provided with plurality of holes,
placing the composting bin substantially embedded below a ground surface in a root zone in a soil mass; an upper aeration portion of the bin projecting above the ground surface, and
wherein the holes are sized to allow ingress and egress of worms into and out of the bin but prevent ingress of rats and other vermin.

19. The method of claim 18 wherein the holes allow nutrients exuding from compostable material in the bin to leach into soil surrounding the bin.

20. The method of claim 18 wherein each composting bin is provided with interlocking structures at each end of the bin; the interlocking structures allowing a line of bins to form a composting and nutrient producing barrier.

21. The method of claim 18 wherein the composting bin is provided with sensors to monitor composting performance; the sensors including temperature, moisture level and soil acidity sensors.

22. A method of natural fertilisation of plants located in a Rhizosphere; said method comprising:
locating a composting chamber within the Rhizosphere of ground; said chamber having sidewalls subtending from a base; apertures located in said sidewalls for communication between the interior of the composting chamber and the Rhizosphere adjacent the composting chamber; said apertures sized to permit passage of composting worms; whereby, in use, said composting chamber is filled with compostable material and worms consume the compostable material generating worm castings which possess a hormone-like signal attracting roots of plants located in the Rhizosphere to grow towards the castings and castings supply actively replicating microbes that the plant roots can ingest directly as a nutrient source.
